(19) United States
(12) Patent Application Publication
(10) Pub. No.: US 2019/0190425 A1
(43) Pub. Date: Jun. 20, 2019

(54) SYSTEM AND METHOD FOR HEALTH MONITORING OF PRIME MOVER COUPLED TO DOUBLY-FED INDUCTION GENERATOR

(71) Applicant: General Electric Company, Schenectady, NY (US)

(72) Inventor: Arvind Kumar TIWARI, Bengaluru (IN)

(21) Appl. No.: 16/322,792

(22) PCT Filed: Jul. 18, 2017
(86) PCT No.: PCT/US2017/042618

§ 371 Date: Feb. 1, 2019

(30) Foreign Application Priority Data
Aug. 4, 2016 (IN) 201641026644

(51) Int. Cl. H02P 21/22; H02S 10/10; H02P 21/20

(52) U.S. Cl. CPC H02P 21/22; H02P 2101/25; H02P 21/20; H02S 10/10

(57) ABSTRACT

A system for health monitoring of a prime mover coupled to a doubly-fed induction generator is disclosed. The DFIG includes a generator having a rotor winding and a stator winding. The system includes first sensors coupled to the stator winding to generate three-phase stator current signals, and second sensors coupled to the rotor winding to generate three-phase rotor current signals. Furthermore, the system includes a signal processor operably coupled to the first sensors and the second sensors and configured to determine a torque profile of the prime mover based on the three-phase stator current signals and the three-phase rotor current signals. Moreover, the signal processor is configured to detect an anomaly associated with the prime mover if the determined torque profile is abnormal.

### BACKGROUND

The present application relates generally to a power generation system for generation of electrical power and more particularly relates to a system and method for health monitoring of a prime mover, such as an engine, employed in the power generation system utilizing a doubly fed induction generator (DFIG).

Typically, power generation systems such as generators use fuels such as diesel, petrol, and the like to generate an electrical power that can be supplied to local electrical loads. Reducing consumption of the fuels is an ongoing effort in achieving low cost and environment friendly power generation systems. To that end, various hybrid power generation systems are available that use a generator operated by a prime mover as one source of electricity and some form of renewable energy source such as a wind turbine as another source of electricity.

Typically, prime movers such as an engine or wind-turbines are employed to operate a generator. Generally, the prime movers are associated with problems or anomalies during operation. Non-limiting examples of such anomalies include a dead cylinder in a multiple cylinder reciprocating engine or a faulty cylinder that causes substantial fuel loss. Traditionally, health of such a power generation system is mostly monitored using a multiple sensor system that is typically installed in the prime mover. Contemporary sensor systems include dedicated sensors for measuring vibration, temperature and pressure for determining any anomalies in the prime mover. Such sensor systems are prone to failures and require frequent maintenance. Further, sensors employed in these sensor systems also require frequent calibration for accurately sensing measurements for detecting the anomalies and also add complexity for carrying out the measurements. Furthermore, these sensor systems involve additional cost to the power generation system.

Accordingly, there is an ongoing need for improving detection of anomalies in prime mover of a power generation system.

### BRIEF DESCRIPTION

In accordance with an embodiment of the present specification, a system (154) for health monitoring of a prime mover (110) is presented. The system (154) is coupled to a doubly-fed induction generator (112) (DFIG), wherein the DFIG (112) includes a generator (120) having a rotor winding (132) and a stator winding (130). The system (154) includes one or more first sensors (156) coupled to the stator winding (130) of the generator (120) to generate three-phase stator current signals. The system (154) further includes one or more second sensors (158) coupled to the rotor winding (132) of the generator (120) to generate three-phase rotor current signals. Furthermore, the system (154) includes a signal processor (160) operably coupled to the one or more first sensors (156) and the one or more second sensors (158). The signal processor (160) is configured to determine a torque profile of the prime mover (110) based on the three-phase stator current signals and the three-phase rotor current signals. Moreover, the signal processor (160) is configured to detect an anomaly associated with the prime mover (110) if the determined torque profile of the prime mover (110) is abnormal.

In accordance with an embodiment of the present specification, a power generation system (102) is presented. The power generation system (102) includes an engine (110) operable at variable speeds. The power generation system (102) further includes a DFIG (112) mechanically coupled to the engine (110), wherein the DFIG (112) includes a generator (120) having a rotor winding (132) and a stator winding (130). Furthermore, the power generation system (102) includes a system (154) for health monitoring of the engine (110), wherein the system (154) is operably coupled to the generator (120) of the DFIG (112). The system (154) includes one or more first sensors (156) operably coupled to the stator winding (130) of the generator (120) to generate three-phase stator current signals. The system (154) further includes one or more second sensors (158) coupled to the rotor winding (132) of the generator (120) to generate three-phase rotor current signals. Furthermore, the system (154) includes a signal processor (160) operably coupled to the one or more first sensors (156) and the one or more second sensors (158). The signal processor (160) is configured to determine a torque profile of the prime mover (110) based on the three-phase stator current signals and the three-phase rotor current signals. Moreover, the signal processor (160) is configured to detect an anomaly associated with the prime mover (110) if the determined torque profile of the prime mover (110) is abnormal.

In accordance with an embodiment of the present specification, a method for health monitoring of a prime mover (110) coupled to a DFIG (112) is presented. The DFIG (112) includes a generator (120) having a rotor winding (132) and a stator winding (130). The method includes receiving three-phase stator current signals from one or more first sensors (156) operably coupled to the stator winding (130). The method further includes receiving three-phase rotor current signals from one or more second sensors (158) operably coupled to the rotor winding (132). Furthermore, the method includes determining a torque profile of the prime mover (110) based on the three-phase stator current signals and the three-phase rotor current signals. Moreover, the method includes determining whether the determined torque profile of the prime mover (110) is abnormal by comparing the determined torque profile with a reference torque profile of the prime mover (110). Additionally, the method includes detecting an anomaly associated with the prime mover (110) in response to determining that the determined torque profile of the prime mover (110) is abnormal.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an electrical power distribution system, in accordance with aspects of the present specification;

FIG. 2 is a phase-vector representation of three-phase stator current signals, in accordance with aspects of the present specification;

FIG. 3 is a phase-vector representation of three-phase rotor current signals, in accordance with aspects of the present specification;

FIG. 4A is a flowchart of an example method of health monitoring of a prime mover coupled to a doubly-fed induction generator (DFIG), in accordance with aspects of the present specification;

FIG. 4B is a flowchart of another example method of health monitoring of a prime mover coupled to a DFIG, in accordance with aspects of the present specification;

FIG. 5 is a graphical representation depicting a d-axis stator current signal and a q-axis stator current signal, in accordance with aspects of the present specification;

FIG. 6 is a graphical representation depicting a d-axis rotor current signal and a q-axis rotor current signal, in accordance with aspects of the present specification;

FIG. 7 is a graphical representation depicting an example reference torque profile of an engine, in accordance with aspects of the present specification;

FIG. 8 is a graphical representation depicting a determined torque profile of an engine, in accordance with aspects of the present specification.

FIG. 9 is a graphical representation depicting d-axis and q-axis current signals of FIGS. 5 and 6, in accordance with aspects of the present specification; and

FIG. 10 is a block diagram of a vehicle, in accordance with aspects of the present specification.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is for explanatory purposes as the method and the system may extend beyond the described embodiments.

In the following specification, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

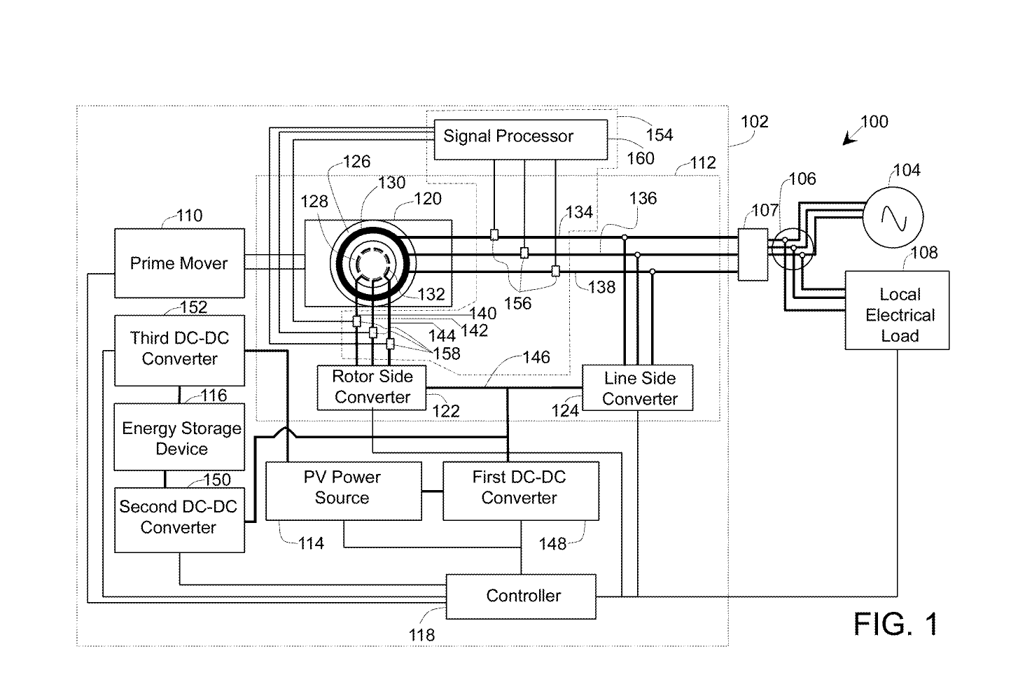

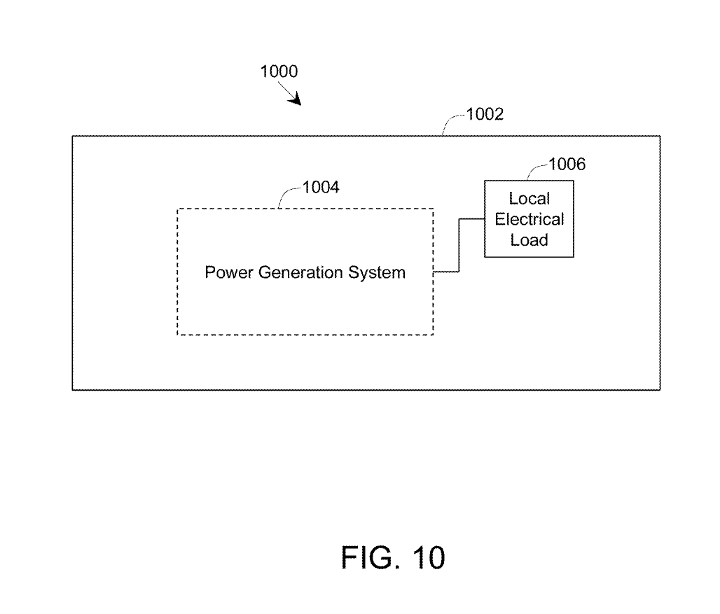

FIG. 1 is a block diagram of an electrical power distribution system (100), in accordance with aspects of the present specification. The electrical power distribution system (100) may include a power generation system (102) coupled to an electric grid (104) at a point of common coupling (PCC) (106). In some embodiments, the power generation system (102) may be coupled to the PCC (106) via a transformer (107). In some embodiments, the PCC (106) may be coupled to a local electrical load (108) to enable supply of an alternating-current (AC) power to the local electrical load (108). Although the embodiment of FIG. 1 is directed to the application of the power generation system (102) in the electrical power distribution system (100), use of the power generation system (102) in other applications including, but not limited to, vehicles, for example, as shown in FIG. 10, is also envisioned within the purview of the present specification.

The electric grid (104) (e.g., utility electricity grid) may be representative of an interconnected network for delivering a grid power (e.g., electricity) from one or more power generation stations to consumers (e.g., the local electrical load (108)) through high/medium voltage transmission lines. The grid power may be received at the PCC (106) from the electric grid (104). The local electrical load (108) coupled to the PCC (106) may include electrical devices that are operable using the electrical power received from the electric grid (104) or the power generation system (102).

In some embodiments, the power generation system (102) may function as a micro-grid or mini-grid. The term “micro-grid,” as used herein refers to a power generation and supply system that is capable of generating and supplying electrical power of less than 10 kW. The term “mini-grid,” as used herein refers to a power generation and supply system that is capable of generating and supplying electrical power of 10 kW and above.

In some embodiments, the power generation system (102) may include a prime mover (110), a doubly-fed induction generator (DFIG) (112), at least one of a photo-voltaic (PV) power source 114, and an energy storage device (116). In some embodiments, the power generation system (102) may also include a controller (118) operatively coupled to at least one of the engine (110) and the DFIG (112). The controller (118) may be configured to control the operations of the prime mover (110) and the DFIG (112). In some embodiments, the DFIG (112) may include one or more of a generator (120), a rotor side converter (122), and a line side converter (124). Furthermore, the power generation system (102) may include a system (154) for health monitoring of the prime mover (110). The system (154) is hereinafter referred to as the health monitoring system (154).

In one embodiment, the controller (118) may include a specially programmed general purpose computer, a microprocessor, a digital signal processor, and/or a microcontroller. The controller (118) may also include input/output ports, and a storage medium, such as, an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. Alternatively, the controller (118) may be implemented as hardware elements such as circuit boards with processors or as software running on a processor such as a commercial, off-the-shelf personal computer (PC), or a microcontroller. In certain embodiments, the prime mover (110), the rotor side converter (122), and the line side converter (124) may include controllers/control units/electronics to control their respective operations under a supervisory control of the controller (118). The controller (118) may be capable of executing program instructions for controlling operations of the power generation system (102), the electrical devices constituting the local electrical load (108).

The prime mover (110) may refer to any system that may aid in imparting a rotational motion to rotary element(s) (e.g., a rotor) of the generator (120). Non-limiting examples of the prime mover (110) may include an engine that may be operable at variable speeds, a gas turbine, a wind turbine, a compressor, or combinations thereof. Hereinafter, for simplicity of illustration, the prime mover (110) is described as the engine capable of being operated at variable speeds. Also, in the description below, the terms “prime mover” and “engine” are interchangeably used. The engine (110) may be an internal combustion engine, an operating speed of which may be varied by the controller (118). More particularly, the engine (110) may be a variable speed reciprocating engine, where the reciprocating motion of a piston is translated into a rotational speed of a crank shaft connected thereto. The engine (110) may be operated by combustion of various fuels including, but not limited to, diesel, natural gas, petrol, liquefied petroleum gas (LPG), biogas, biomass, producer gas, and the like. The engine (110) may also be operated using waste heat cycle. It is to be noted that the scope of the present specification is not limited by the types of fuel and the engine (110) employed in the power generation system (102).

The DFIG (112) may include the generator (120). In a non-limiting example, the generator (120) may be a wound rotor induction generator. The generator (120) may include a stator (126), a rotor (128), a stator winding (130) disposed on the stator (126), and a rotor winding (132) disposed on the rotor (128). The generator (120) may be electrically coupled to the PCC (106). More particularly, the stator winding (130) may be coupled (directly or indirectly) to the PCC (106).

In some embodiments, both the stator winding (130) and the rotor winding (132) may be multi-phase winding, such as a three-phase winding. For example, the stator winding (130) may include three-phase lines a stator phase-a, a stator phase-b, and a stator phase-c respectively indicated by reference numerals (134), (136), and (138). Similarly, the rotor winding (132) may include three-phase lines a rotor phase-a, a rotor phase-b, and a rotor phase-c respectively indicated by reference numerals (140), (142), and (144).

The DFIG (112) may be mechanically coupled to the engine (110). In some embodiments, the rotor (128) of the generator (120) may be mechanically coupled to the crank shaft of the engine (110), such that during operation, rotations of the crank shaft may cause a rotary motion of the rotor (128) of the generator (120). In some embodiments, the crank shaft of the engine (110) may be coupled to the rotor (128) of the generator (120) through one or more gears. In operation, the generator (120) may be configured to generate a first electrical power (P at stator, the stator winding (130) and to generate or absorb a second electrical power (Proton) at the rotor winding (132) depending on an operating speed (co) of the engine (110).

In some embodiments, the DFIG (112) may further include the rotor side converter (122) and the line side converter (124). Each of the rotor side converter (122) and the line side converter (124) may act as an AC-DC converter or a DC-AC converter, and may be controlled by the controller (118). The rotor side converter (122) may be electrically coupled to the rotor winding (132). Further, the line side converter (124) may be electrically coupled to the stator winding (130) at the PCC (106). The line side converter (124) may further be coupled to the PCC (106), directly or via a transformer (not shown in FIG. 1). In one embodiment, the rotor side converter (122) and the line side converter (124) are also coupled to each other. For example, the rotor side converter (122) and the line side converter (124) are electrically coupled to each other via a direct-current (DC) link 146.

Further, the power generation system (102) may include at least one of a renewable energy source, such as a PV power source (114), and the energy storage device (116) electrically coupled to the DFIG (112) at the DC-link (146). The PV power source (114) may include one or more PV arrays (not shown in FIG. 1), where each PV array may include at least one PV module (not shown in FIG. 1). A PV module may include a suitable arrangement of a plurality of PV cells (diodes and/or transistors). The PV power source (114) may generate a DC voltage constituting a solar electrical power (Pₛ) that depends on solar insolation, weather conditions, and/or time of the day. Accordingly, the PV power source (114) may be configured to supply the solar electrical power (Pₛ) to the DC-link (146). Although in the ongoing description, the PV power source (114) is described as one embodiment of the renewable energy source, use of other forms of renewable energy sources capable of generating and/or supplying DC current is also envisioned within the purview of the present specification.

In some embodiments, the PV power source (114) may be electrically coupled to the DFIG (112) at the DC-link (146) via a first DC-DC converter (148). The first DC-DC converter (148) may be electrically coupled between the PV power source (114) and the DC-link (146). In such embodiments, the solar electrical power (Pₛ) may be supplied from the PV power source (114) to the DC-link (146) via the first DC-DC converter (148). The first DC-DC converter (148) may be operated as a buck converter, a boost converter, or a buck-boost converter, and may be controlled by the controller (118).

The energy storage device (116) may include arrangements employing one or more batteries, capacitors, and the like. In some embodiments, the energy storage device (116) may be electrically coupled to the DFIG (112) at the DC-link (146) to supply a third electrical power to the DC-link (146). In some embodiments, the energy storage device (116) may be electrically coupled to the DFIG (112) at the DC-link (146) via a second DC-DC converter (150). The second DC-DC converter (150) may be electrically coupled between the energy storage device (116) and the DC-link (146). In such embodiments, the third electrical power may be supplied from the energy storage device (116) to the DC-link (146) via the second DC-DC converter (150). The second DC-DC converter (150) may be operated as a buck converter, a boost converter, or a buck-boost converter, and may be controlled by of the controller (118).

In some embodiments, the power generation system (102) may also include a third DC-DC converter (152). The third DC-DC converter (152) may be electrically coupled between the energy storage device (116) and the PV power source (114). In some embodiments, the third DC-DC converter (152) may be configured to charge the energy storage device (116) via the PV power source (114). For example, in some embodiments, the energy storage device (116) may receive a charging current via the third DC-DC converter (152) from the PV power source (114). The third DC-DC converter (152) may be operated as a buck converter, a boost converter, or a buck-boost converter, and may be controlled by the controller (118).

In some embodiments, in addition to being operatively coupled to the engine (110), the generator (120), the rotor side converter (122), and the line side converter (124), the controller (118) may be operatively coupled to at least one of the first DC-DC converter (148), the second DC-DC converter (150), and the third DC-DC converter (152) to control their respective operations. Furthermore, in some embodiments, the controller (118) may also be operatively coupled to the local electrical load (108) to selectively connect and disconnect the respective electrical device to manage load.

In some embodiments, the power generation system (102) may further include the health monitoring system (154) for health monitoring of the prime mover, for example, the engine (110). As depicted in FIG. 1, the health monitoring system (154) is operably coupled to the generator (120). In some embodiments, the health monitoring system (154) may include one or more first sensors (156), one or more second sensors (158), and a signal processor (160). In some embodiments, the first sensors (156) and second sensors (158) may include current sensors. In some other embodiments, the first sensors (156) and second sensors (158) may include voltage sensors.

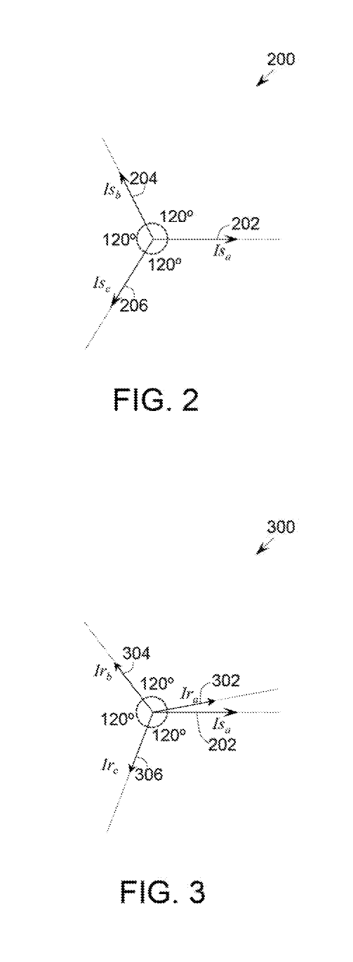

As depicted in FIG. 1, the first sensors (156) may be coupled to the stator winding (130). More particularly, the first sensors (156) may be coupled to the stator phase lines (134), (136), and (138) by way of electrical or electro-magnetic coupling. During operation, the first sensors (156) are configured to generate three-phase stator current signals. For example, each first sensor (156) is configured to generate an AC signal indicative of a current flowing through the respective stator phase line coupled thereto. Typically, the stator current signal generated by each first sensor (156) is displaced in phase by 120 degrees with respect to the stator current signal generated by other first sensor (156) (see FIG. 2).

Moreover, the second sensors (158) may be coupled to the rotor winding (132). In particular, the second sensors (158) may be coupled to the rotor phase lines (140), (142), and (144) by way of electrical or electro-magnetic coupling. During operation, the second sensors (158) are configured to generate three-phase rotor current signals. For example, each second sensor (158) is configured to generate an AC signal indicative of a current flowing through the respective rotor phase line coupled thereto. Typically, the rotor current signal generated by each second sensor (158) is displaced in phase by 120 degrees with respect to the rotor current signal generated by the other second sensor (158) (see FIG. 3).

The health monitoring system (154) may further include the signal processor (160) communicatively coupled to the first sensors (156) and second sensors (158). In the embodiment of FIG. 1, the signal processor (160) is shown as coupled to the first sensors (156) and second sensors (158) via wired connections. In some other embodiments, the first sensors (156) and second sensors (158) may be communicatively coupled to the signal processor (160) over a wireless communication medium. The wireless communication medium between the signal processor (160) and the first sensors (156) and second sensors (158) may be effected by wireless communication techniques based on Bluetooth®, Wi-Fi (IEEE 802.11), WiMAX® (IEEE 802.16), Wi-Bro®, cellular communication techniques, such as, but not limited to. global system for mobile (GSM) communications or code division multiple access (CDMA), data communication techniques, including, but not limited to, broadband, 2G, 3G, 4G, or 5G.

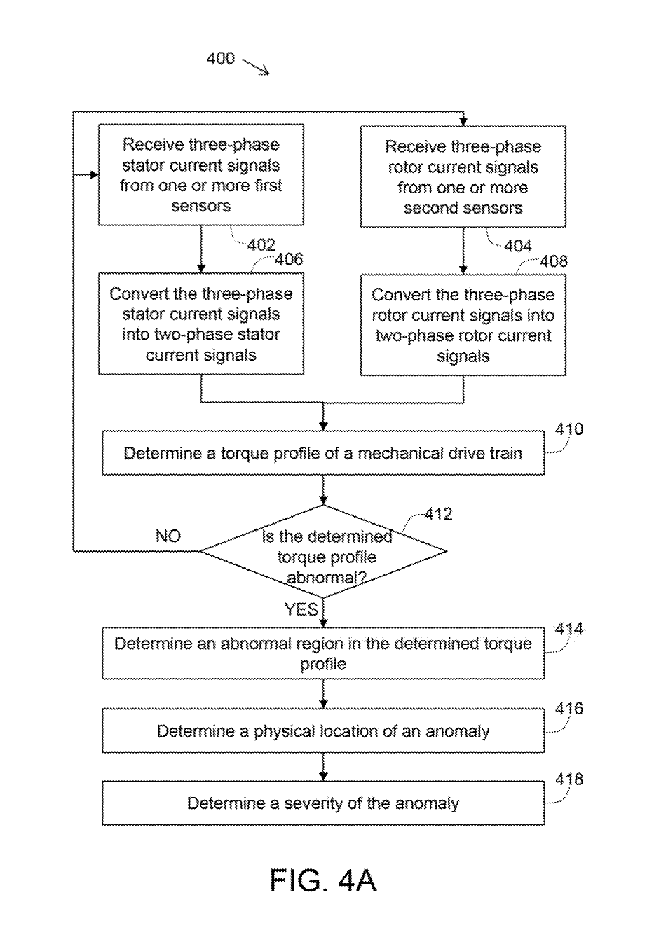

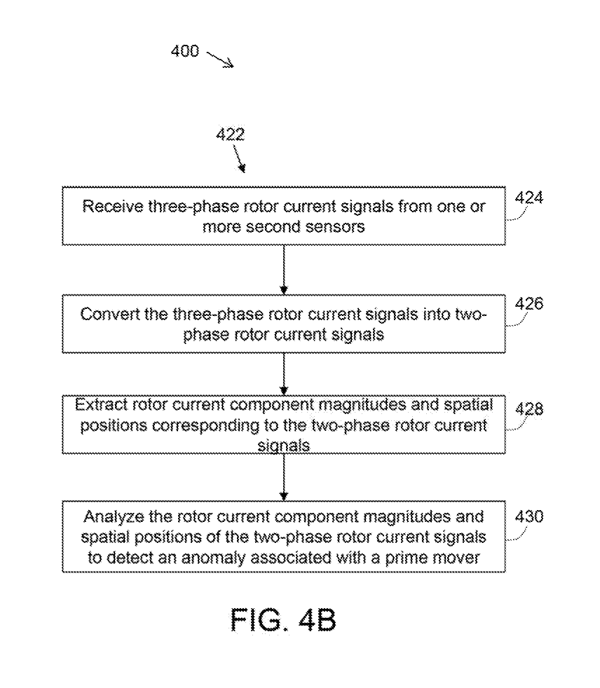

In some embodiments, the signal processor (160) may include hardware, firmware, and/or specialized software for carrying out processing of analog and/or digital electrical signals. More particularly, the signal processor (160) may include a single core or multi-core processing units. In certain embodiments, the signal processor (160) may be similar to the controller (118). The signal processor (160) may aid in executing a method for health monitoring of the prime mover, for example, the engine (110) coupled to the DFIG (112) (see FIGS. 4A and 4B). More particularly, the signal processor (160) may include hardware and/or software including program instructions for aiding in detecting anomalies in the engine (110) coupled to the DFIG (112).

Alternatively, in certain embodiments, functionalities of the signal processor (160) may be executed by the controller (118) and use of the signal processor (160) may be avoided. In such a configuration, the first sensors (156) and the second sensors (158) may be coupled to the controller (118).

FIG. 2 is a phase-vector representation (200) of the three-phase stator current signals Isₐ, Is_{b}, and Is_{c} generated by the first sensors (156), in accordance with aspects of the present specification. As depicted in FIG. 2, reference numerals (202), (204), and (206) represent phase-vectors corresponding to the stator current signals Isₐ, Is_{b}, and Is_{c} generated by the first sensors (156) disposed respectively at the stator phase lines (134), (136), and (138). The stator current signals Isₐ, Is_{b}, and Is_{c} represented by the phase vectors (202), (204), and (206) are displaced in phase by 120 degrees from one another. Further, a length of the respective phase vectors (202), (204), and (206) is representative of magnitude of the stator current on corresponding one of the stator phase lines (134), (136), and (138).

As depicted in FIG. 2, the three-phase stator current vectors are shown to be equal in magnitude and are separated from one another by 120 degrees. The stator current signals Isₐ, Is_{b}, and Is_{c} may be respectively represented using relationship represented by Equations 1, 2 and 3 below:

$$\begin{matrix}{Is}_{a} = \vert Is \vert cos ( {ω}_{s} t - {δ}_{s} ) & Equation ( 1 ) \\ {Is}_{b} = \vert Is \vert cos ( {ω}_{s} t - \frac{2 π}{3} - {δ}_{s} ) & Equation ( 2 ) \\ {Is}_{c} = \vert Is \vert cos ( {ω}_{s} t + \frac{2 π}{3} - {δ}_{s} ) & Equation ( 3 )\end{matrix}$$

where, |Is| represents magnitude of the stator current signals Isₐ, Is_{b}, and Is_{c}, ωₛ represents angular velocity of stator magnetic field, and δₛ represents a phase lag of the stator current signals Isₐ, Is_{b}, and Is_{c} with respect to corresponding phase voltages (not shown in FIG. 2).

FIG. 3 is a phase-vector representation (300) of the three-phase rotor current signals Irₐ, Ir_{b}, and Ir_{c} generated by the second sensors (158), in accordance with aspects of the present specification. As depicted in FIG. 3, reference numerals (302), (304), and (306) represent phase-vectors corresponding to the rotor current signals Irₐ, Ir_{b}, and Ir_{c} generated by the second sensors (158) disposed respectively at the rotor phase lines (140), (142), and (144). The rotor current signals Irₐ, Ir_{b}, and Ir_{c} represented by the phase vectors (302), (304), and (306) are displaced in phase by 120 degrees from one another. Further, a length of the respective phase vectors (302), (304), and (306) is representative of magnitude of the rotor current on corresponding one of the rotor phase lines (140), (142), and (144). In some embodiments, the rotor current signals Irₐ, Ir_{b}, and Ir_{c} may be displaced by a first non-zero phase angle with respect to the stator current signals Isₐ, Is_{b}, and Is_{c}, respectively. By way of example, in FIG. 3, the rotor current signals Irₐ, Ir_{b}, and Ir_{c} are shown with reference to the stator current signal Isₐ.

As depicted in FIG. 3, the three-phase rotor current vectors are shown to be equal in magnitude and are separated from one another by 120 degrees. The rotor current signals Irₐ, Ir_{b}, and Ir_{c} may be respectively represented using relationship represented by Equations 4, 5 and 6 below:

$$\begin{matrix}{Ir}_{a} = \vert Ir \vert cos ( {ω}_{r} t - {δ}_{r} ) & Equation ( 4 ) \\ {Ir}_{b} = \vert Ir \vert cos ( {ω}_{r} t - \frac{2 π}{3} - {δ}_{r} ) & Equation ( 5 ) \\ {Ir}_{c} = \vert Ir \vert cos ( {ω}_{r} t + \frac{2 π}{3} - {δ}_{r} ) & Equation ( 6 )\end{matrix}$$

where, |Ir| represents magnitude of the rotor current signals Irₐ, Ir_{b}, and Ir_{c}, ωᵣ represents angular velocity of rotor, and δᵣ represents a phase lag of the rotor current signals Irₐ, Ir_{b}, and Ir_{c} with respect to corresponding phase voltages (not shown in FIG. 3).

FIG. 4A is a flowchart (400) of an example method of health monitoring of a prime mover, for example, the engine (110), coupled to the DFIG (112), in accordance with aspects of the present specification. The method of flowchart (400) may include blocks (402)-(418). In the embodiment of FIG. 4A, the signal processor (160) is described as performing the method of flowchart (400). However, it is to be noted that in some embodiments, use of the controller (118) for executing the method of flowchart (400) is also contemplated.

At block (402), the signal processor (160) may be configured to receive the three-phase stator current signals from the one or more first sensors (156). Further, at block (404), the signal processor (160) may be configured to receive the three-phase rotor current signals from the one or more second sensors (158). In some embodiments, the signal processor (160) may receive the three-phase stator current signals and the three-phase rotor current signals respectively from the first sensors (156) and the second sensors (158) over wired connections. In some embodiments, the signal processor (160) may receive the three-phase stator current signals and the three-phase rotor current signals respectively from the first sensors (156) and the second sensors (158) over a wireless communication medium.

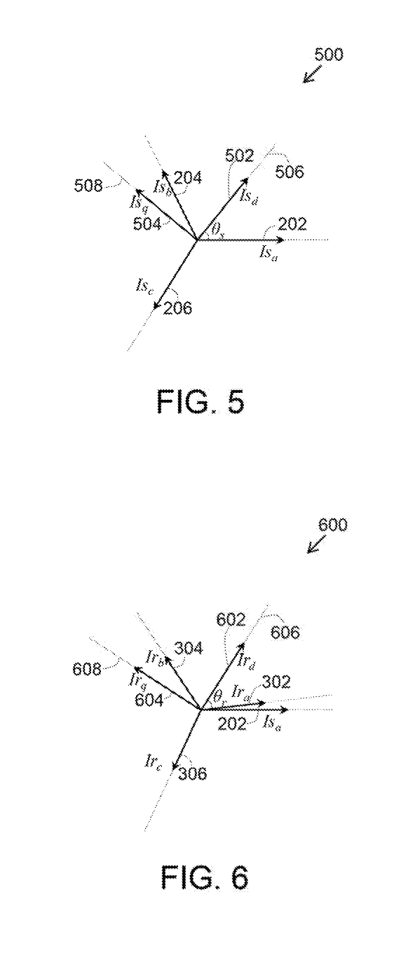

Moreover, at block (406), the signal processor (160) may be configured to convert the three-phase stator current signals Isₐ, Is_{b}, and Is_{c} (respectively represented by phase vectors (202), (204), and (206) in FIG. 2) into two-phase stator current signals including a d-axis stator current signal Is_{d} and a q-axis stator current signal Is_{q} (see FIG. 5). Referring now to FIG. 5, a graphical representation (500) depicting a d-axis stator current signal Is_{d} (502) and a q-axis stator current signal Is_{q} (504) generated at the block (406) is shown, in accordance with aspects of the present specification. For ease of illustration, in FIG. 5, the d-axis stator current signal Is_{d} (502) and the q-axis stator current signal Is_{q} (504) are shown with reference to the three-phase stator current signals Isₐ, Is_{b}, and Is_{c} respectively represented by phase vectors (202), (204), and (206). The d-axis stator current signal Is_{d} (502) is oriented along a d-axis (506) and the q-axis stator current signal Is_{q} (504) is oriented along a q-axis (508). The q-axis (508) may be oriented at ninety (90) degrees with reference to the d-axis (506). In some embodiments, the d-axis (506) may be displaced in phase by an angle θₛ with reference to the stator current signal Isₐ, where θₛ=ωₛt. In some embodiments, the d-axis stator current signal Is_{d} (502) and the q-axis stator current signal Is_{q} (504) may be respectively represented using relationship represented by Equations 7 and 8 below:

$$\begin{matrix}{Is}_{d} = \sqrt{\frac{3}{2}} \vert Is \vert cos ( {δ}_{s} ) \\ & Equation ( 7 ) \\ {Is}_{q} = \sqrt{\frac{3}{2}} \vert Is \vert sin ( {δ}_{s} ) & Equation ( 8 )\end{matrix}$$

Referring back to FIG. 4A, at block (408), the signal processor (160) may be configured to convert the three-phase rotor current signals Irₐ, Ir_{b}, and Ir_{c} (respectively represented by phase vectors (302), (304), and (306) in FIG. 3) into two-phase rotor current signals including a d-axis rotor current signal Ir_{d} and a q-axis rotor current signal Ir_{q} (see FIG. 6). Referring now to FIG. 6, a graphical representation (600) depicting a d-axis rotor current signal Ir_{d} (602) and a q-axis rotor current signal Ir_{q} (604) generated at the block (406) is shown, in accordance with aspects of the present specification. For ease of illustration, in FIG. 6, the d-axis rotor current signal Ir_{d} (602) and the q-axis rotor current signal Ir_{q} (604) are shown with reference to the three-phase rotor current signals Irₐ, Ir_{b}, and Ir_{c} respectively represented by phase vectors (302), (304), and (306). Furthermore, the three-phase rotor current signals Irₐ, Ir_{b}, Ir_{c} and the two-phase rotor current signals Ir_{d} and Ir_{q} are shown with reference to the three-phase stator current signal Isₐ. The d-axis rotor current signal Ir_{d} (602) is oriented along a d-axis (606) and the q-axis rotor current signal Ir_{q}(604) is oriented along a q-axis (608). The q-axis (608) may be oriented at ninety degrees with reference to the d-axis (606). In some embodiments, the d-axis (606) may be displaced in phase by an angle θᵣ with reference to the rotor current signal Irₐ, where θᵣ=ωᵣt. Moreover, in some embodiments, the d-axis rotor current signal Ir_{d} (602) and the q-axis rotor current signal Ir_{q} (604) may be displaced by a second non-zero phase angle with respect to the d-axis stator current signal Is_{d} (502) and the q-axis stator current signal Is_{q} (504), respectively.

The d-axis rotor current signal Ir_{d} (602) and the q-axis rotor current signal Ir_{q} (604) may be respectively represented using relationship represented by Equations 9 and 10 below:

$$\begin{matrix}{Ir}_{d} = \sqrt{\frac{3}{2}} \vert Ir \vert cos ( {δ}_{r} ) & Equation ( 9 ) \\ {Ir}_{q} = \sqrt{\frac{3}{2}} \vert Ir \vert sin ( {δ}_{r} ) & Equation ( 10 )\end{matrix}$$

Referring back to FIG. 4A, the block (408) is shown as being performed after the block (406). In some embodiments, alternatively, the block (408) may be performed before the block (406). In some embodiments, the blocks (406) and (408) may be performed in parallel. In some embodiments, the while the block (406) may be performed after the block (402), the block (408) may be performed after the block (404).

Further, at block (410), the signal processor (160) may be configured to determine a torque profile of the prime mover, for example, the engine (110). The signal processor (160) may determine the torque profile based on the three-phase stator current signals Isₐ, Is_{b}, and Is_{c} and the three-phase rotor current signals Irₐ, Ir_{b}, and Ir_{c}. More particularly, the torque profile may be determined based on the two-phase stator current signals Is_{d}, Is_{q} and the two-phase rotor current signals Ir_{d}, Ir_{q} that are derived based on the respective three-phase current signals at blocks 406 and 408, respectively. In some embodiments, a torque T exerted on the generator (120) by the engine (110) may be represented by Equation 11 below:

$$T = p \frac{{P}_{g}}{{ω}_{r}} \qquad Equation ( 11 )$$

where, P_{g} represents an active power generated by the generator (120).

In some embodiment active power generated by the generator (120) (P_{g}) may be represented by Equation 12 below:

$${P}_{g} = \frac{3}{2} {ω}_{s} {L}_{m} ( 1 - s ) ( {Ir}_{d} {Is}_{q} - {Ir}_{q} {Is}_{d} ) \qquad Equation ( 12 )$$

where, Lₘ represents a magnetizing inductance of the generator (120).

Accordingly, by replacing the Equation 12 into Equation 11, the torque T (hereinafter also referred to as a torque profile) exerted on the generator (120) by the engine (110) may be represented by Equation 13 below:

$$T = \frac{3}{2} {pL}_{m} ( {Ir}_{d} {Is}_{q} - {Ir}_{q} {Is}_{d} ) \qquad Equation ( 13 )$$

In a non-limiting example, the torque profile T of engine (110) may be graphically represented as shown in FIG. 8 (described later).

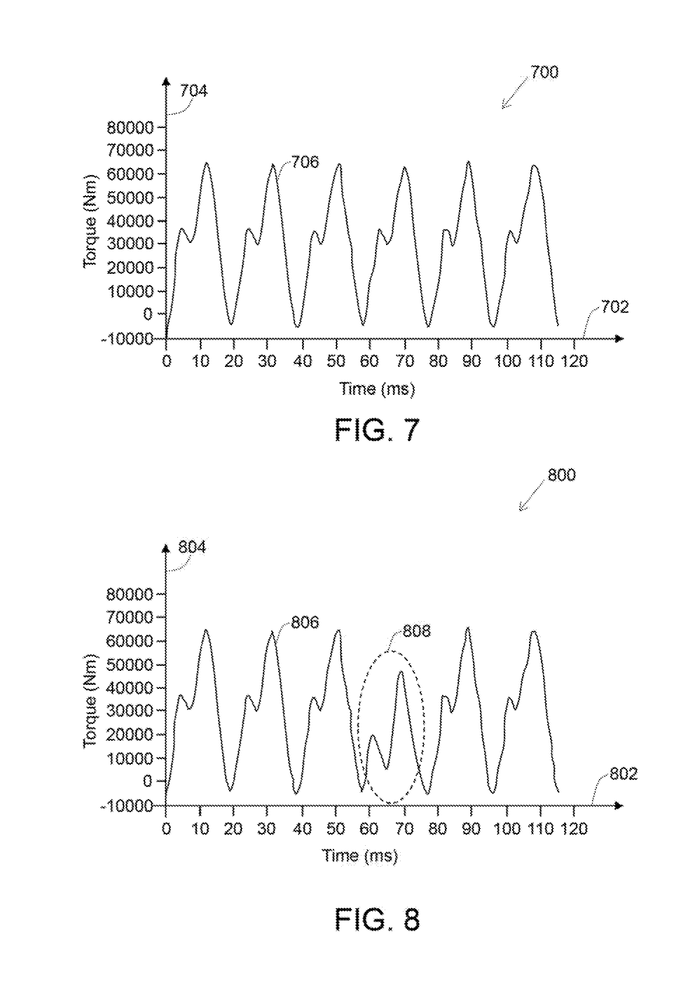

Furthermore, at block (412), a check may be performed by the signal processor (160) to determine whether the determined torque profile (e.g., the torque profile T determined at block (410)) is abnormal. Accordingly, the signal processor (160) may compare the determined torque profile T with a reference torque profile T_{ref} (see FIG. 7—described later) of the engine (110). The reference torque profile T_{ref} of the engine (110) may be stored in a memory associated with the signal processor (160). If the determined torque profile T is similar to the reference torque profile T_{ref}, the signal processor (160) may determine that the engine (110) is operating normally and the method may be looped back to blocks (402) and (404). However, if the determined torque profile T is not similar to the reference torque profile T_{ref}, the signal processor (160) may determine that the engine (110) is anomalous. Subsequently, the signal processor (160) may be configured to detect an anomaly associated with the prime mover, for example, the engine (110) based on a position of an abnormal region in the determined torque profile T, and the d-axis stator current signal Is_{d} (502) and the d-axis rotor current signal Ir_{d} (602) corresponding to the abnormal region. The method of detecting the anomaly associated with the engine (110) may include one or more of blocks (414), (416), and (418). Non-limiting examples of the types of the anomaly may include a malfunctioning of one or more cylinders, quality degradation of a lubricant, cylinder knocking, cylinder misfiring, or combinations thereof.

At block (414), the signal processor (160) may be configured to determine the abnormal region in the determined torque profile T. The term “abnormal region” is defined a portion of the determined torque profile T which does not match with a corresponding portion in the reference torque profile T_{ref}. In some embodiments, if the engine (110) is multi-cylinder engine, a position of the abnormal region in the determined torque profile T may be indicative of a cylinder which is anomalous. The position of the abnormal region may be identified by a range of time values corresponding to the abnormal region. Accordingly, at block (416), the signal processor (160) may be configured to determine a physical location of the anomaly in the engine (110). The physical location may be indicative of cylinder identifiers corresponding to one or more anomalous cylinders.

In some embodiments, to aid in determining the physical location of the anomaly in the engine (110), the signal processor (160) may be configured to determine an angular position of the rotor (128) of the generator (120). Accordingly, timing sequence of the cylinders of the engine (110) may be defined with respect to the angular position of the rotor (128). In some embodiments, the signal processor (160) may determine the angular position of the rotor (128) based on electrical signal received from one or more rotor position sensors (not shown in FIG. 1) disposed within the generator (120). In some other embodiments, the signal processor (160) may estimate the angular position of the rotor (128) based on one or more of the stator current signals Isₐ, Is_{b}, and Is_{c}, rotor current signals Irₐ, Ir_{b}, and Ir_{c}, the d-axis stator current signal Is_{d} (502), the q-axis stator current signal Is_{q} (504), the d-axis rotor current signal Ir_{d} (602), and the q-axis rotor current signal Ir_{q}(604).

A mapping between cylinder identifiers and corresponding ranges of time values on an X-axis (see FIG. 7) may be stored as a look-up table in the memory associated with the signal processor (160). Therefore, the signal processor (160) may identify the anomalous cylinder(s) based on the position of the abnormal region and the look-up table having the mapping between the cylinder identifiers and corresponding ranges of time values.

Additionally, in some embodiments, it may be useful to determine a severity of the anomaly. Accordingly, at block (418), the signal processor (160) may be configured to determine the severity of the anomaly associated with the prime mover such as the engine (110).

In some embodiments, an anomaly in a cylinder of the multi-cylinder engine (110), may cause corresponding change in the phase rotor current signals Irₐ, Ir_{b}, and Ir_{c} at a corresponding timing sequence of the anomalous cylinder. For example, during a power-cycle of the anomalous cylinder, a piston of the anomalous cylinder and hence the rotor may not operate normally. In some embodiments, the rotor may slip behind a desired rotor magnetic field. Accordingly, there may exist an irregularity in the three-phase rotor current signals Irₐ, Ir_{b}, and Ir_{c} at the corresponding power cycle of the anomalous cylinder. Accordingly, any such irregularity in the three-phase rotor current signals Irₐ, Ir_{b}, and Ir_{c} may be captured in the corresponding the d-axis and q-axis rotor current signals (602, 604). In the d-axis and q-axis rotor current signals (602, 604), such irregularities may be captured by variations in the phase angle, magnitude, rate of change of the magnitude, and rate of change of the phase angle.

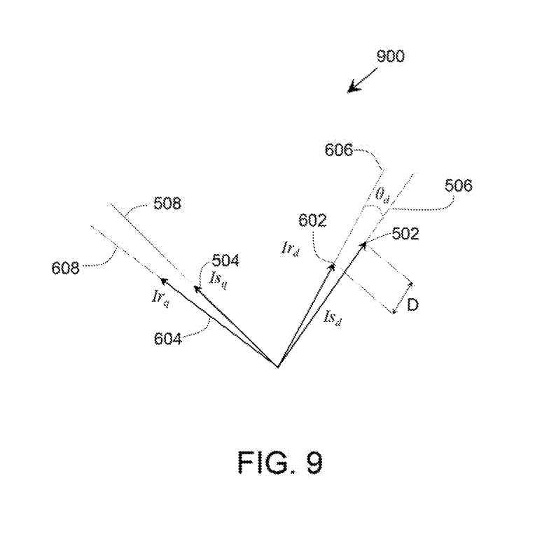

In some embodiments, the signal processor (160) may determine the severity of the anomaly based on the d-axis stator current signal Is_{d} (502) and the d-axis rotor current signal Ir_{d} (602) corresponding to the abnormal region. More particularly, in one embodiment, the signal processor (160) may be configured to determine the severity of the anomaly based on a difference, “D” (see FIG. 9) in the magnitudes of the d-axis stator current signal Is_{d} (502) and the d-axis rotor current signal Ir_{d} (602). In another embodiment, the signal processor (160) may be configured to determine the severity of the anomaly based on a difference (“θ_{d}”—see FIG. 9) in the phase angles of the d-axis stator current signal Is_{d} (502) and the d-axis rotor current signal Ir_{d} (602). In some embodiments, a rate of change of the difference (D) in magnitudes and/or the difference (θ_{d}) in phase angles may be indicative of the severity of the anomaly and may be used by the signal processor (160) to determine severity of the anomaly. In some embodiments, a combination of one or more of the difference (D) in magnitudes, the difference (θ_{d}) in phase angles, the rate of change of the difference (θ_{d}), and the rate of change of the difference (D) in magnitudes of the d-axis stator current signal Is_{d} (502) and the d-axis rotor current signal Ir_{d} (602) may be used by the signal processor (160) to determine the severity of the anomaly.

FIG. 4B is a flowchart 422 of another example method of health monitoring of the prime mover (110) coupled to the DFIG (112), in accordance with aspects of the present specification.

At block (424), the signal processor (160) may be configured to receive the three-phase rotor current signals Irₐ, Ir_{b}, and Ir_{c} from the one or more second sensors (158). Moreover, at block (426), the signal processor (160) may be configured to convert the three-phase rotor current signals Irₐ, Ir_{b}, and Ir_{c} (respectively represented by phase vectors (302), (304), and (306) in FIG. 3) into two-phase rotor current signals including a d-axis rotor current signal Ir_{d} and a q-axis rotor current signal Ir_{q} (see FIG. 6). In some embodiments, the blocks 424 and 426 of FIG. 4B are similar to blocks 404 and 408, respectively, of FIG. 4A.

Furthermore, at block (428), the signal processor (160) may be configured to extract rotor current component magnitudes and spatial positions corresponding to the two-phase rotor current signals. For example, the rotor current component magnitudes may be representative of magnitudes of the d-axis rotor current signal Ir_{d} and the q-axis rotor current signal Ir_{q}. The spatial positions may be representative of angular positions of the d-axis rotor current signal Ir_{d} and the q-axis rotor current signal Ir_{q}.

Additionally, at block (430), the signal processor (160) may be configured to analyze the rotor current component magnitudes and/or spatial positions corresponding to the two-phase rotor current signals Ir_{d}, Ir_{q} to detect an anomaly associated with the prime mover (110). In some embodiments, the signal processor (160) may analyze the rotor current component magnitudes and/or spatial positions by way of determining a rate of change of the rotor current component magnitude and/or rate of change of the spatial position of the d-axis rotor current component Ir_{d}, for example. Subsequently, the signal processor (160) may be configured to compare the rate of change of the rotor current component magnitude and/or the rate of change of the spatial position of the d-axis rotor current component Ir_{d} with corresponding threshold values. The threshold values corresponding to the rotor current component magnitude and/or the rate of change of the spatial position may be representative of minimum values of the rotor current component magnitude and/or the rate of change of the spatial position that indicate beginning of an anomalous behavior of the prime mover (110). If the values of the rate of change of the rotor current component magnitude and/or rate of change of the spatial position of a d-axis rotor current component Ir_{d} exceeds the corresponding threshold values the signal processor (160) may determine that the prime mover (110) is anomalous.

In some embodiments, the values of the rate of change of the rotor current component magnitude and/or rate of change of the spatial position of a d-axis rotor current component Ir_{d} may be indicative of a severity of the anomaly associated with the prime mover (110). Accordingly, the signal processor (160) may be configured to determine the severity of the anomaly based on the magnitudes of the rate of change of the rotor current component magnitude and/or rate of change of the spatial position of a d-axis rotor current component Ir_{d}.

In certain embodiments, the methods of FIGS. 4A and 4B may be combined and the signal processor (160) may be configured to execute steps of both FIGS. 4A and 4B. Additionally, in some embodiments, the severity determined at block (418) may be compared with the severity determined by the analysis performed at block (430) to validate the severities determined at blocks (418) and (430). In certain embodiments, the severity determined at block (418) may be combined with the severity determined by the analysis performed at block (430). For example, an average severity indicative of an average value of the severities determined at blocks (418) and (430) may be determined.

Referring now to FIG. 7, a graphical representation (700) depicting the reference torque profile T_{ref} of the engine (110) is presented, in accordance with aspects of the present specification. The X-axis (702) represents time in milliseconds (ms) and Y-axis (704) represents a torque value in Newton-meter (Nm). In some embodiments, the time values on the X-axis 702 may be defined with respect to the angular position of the rotor (128) as determined/estimated by the signal processor (160). A curve (706) represents the reference torque profile T_{ref}. In the embodiment, the reference torque profile T_{ref} 706 may correspond to the engine (110) having twelve (12) cylinders, for example.

FIG. 8 is a graphical representation (800) depicting the determined torque profile T of the engine (110), in accordance with aspects of the present specification. The X-axis (802) represents time in milliseconds (ms) and Y-axis (804) represents a torque value in Newton-meter (Nm). In some embodiments, the time values on the X-axis 802 may be defined with respect to the angular position of the rotor (128) as determined/estimated by the signal processor (160). A curve (806) represents the torque profile T determined at block (410). A portion of the torque profile T (806) as indicated within a circle (808) represents the abnormal region as referenced hereinabove. More particularly, the torque profile T (806) of the abnormal region (808) does not match with a corresponding portion of the reference torque profile T_{ref}.

FIG. 9 is a graphical representation (900) depicting d-axis and q-axis current signals of FIGS. 5 and 6, in accordance with accordance with aspects of the present specification. As depicted in FIG. 9, in some embodiments, the d-axis rotor current signal Ir_{d} (602) may be displaced in phase from the d-axis stator current signal Is_{d} (502) by a phase angle θ_{d}. Moreover, the descriptor “D” represents a difference in magnitudes of the d-axis rotor current signal Ir_{d} (602) and the d-axis stator current signal Is_{d}. As noted in block (418) of FIG. 4A, the phase angle θ_{d}, a rate of change of the magnitude of the d-axis rotor current signal Ir_{d} (602), the magnitude difference D, a rate of change of θ_{d}, a rate of change of the magnitude difference D, or combinations thereof may be indicative of the severity of the anomaly associated with a prime mover, such as the engine (110).

FIG. 10 is a block diagram of a vehicle (1000), in accordance with aspects of the present specification. The term “vehicle” as used herein may be defined as a movable machine capable of transporting living beings, or non-living items, for example, goods. Non-limiting examples of the vehicle (1000) may include a motor vehicle (e.g., a motorcycle, a car, a truck, or a bus), a railed vehicle (e.g., a train or a tram), a watercraft (e.g., a ship or a boat), an aircraft, or a spacecraft.

In some embodiments, the vehicle (1000) may include a vehicle body (1002) and a power generation system (1004) disposed in the vehicle body (1002). The power generation system (1004) may be similar to the power generation system (102) of FIG. 1. In particular, the power generation system (1004) may also include a system such as the system 154 for aiding in the health monitoring a prime mover, for example, an engine (not shown) of the vehicle (1000). Moreover, in such an instance when the power generation system (1004) is employed in the vehicle (1000), one or more elements of the power generation system (1004) may be disposed outside or on the vehicle body 1002. For example, a renewable energy source (not shown in FIG. 10), for example, the PV power source (114) may be disposed on an outer surface of the vehicle body (1002).

In some embodiments, the power generation system (1004) may be electrically coupled to the local electrical load (1006) of the vehicle (1000). Non-limiting examples of the local electrical load (1006) of the vehicle (1000) lighting devices, entertainment systems, air-conditioners, fans, or combinations thereof.

Any of the foregoing method blocks and/or system elements may be suitably replaced, reordered, or removed, and additional blocks and/or system elements may be inserted, depending on the needs of a particular application, and that the systems of the foregoing embodiments may be implemented using a wide variety of suitable processes and system elements and are not limited to any particular computer hardware, software, middleware, firmware, microcode, etc.

Furthermore, the foregoing examples, demonstrations, and method blocks such as those that may be performed by the controller (118) may be implemented by suitable code on a processor-based system, such as a general-purpose or special-purpose computer. Different implementations of the systems and methods may perform some or all of the blocks described herein in different orders, parallel, or substantially concurrently. Furthermore, the functions may be implemented in a variety of programming languages, including but not limited to C++ or Java. Such code may be stored or adapted for storage on one or more tangible or non-transitory computer readable media, such as on data repository chips, local or remote hard disks, optical disks (that is, CDs or DVDs), memory or other media, which may be accessed by a processor-based system to execute the stored code. Note that the tangible media may include paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

In accordance with some embodiments of the present specification, the health monitoring system and method aids in diagnosing anomalies associated with the prime mover coupled to the DFIG. In particular, in comparison to the traditional detection techniques, the health monitoring system and method in accordance with some embodiments of the present specification is less costly as use is of the dedicated sensors such as sensors for measuring vibration, temperature, and pressure is be avoided. Also, the sensors as used in the health monitoring system of the present specification, may communicate the information about the generated signals (e.g., the three-phase stator current signals and the three-phase rotor current signals) wirelessly to the signal processor aiding in remote monitoring and diagnosing of the prime mover.

The present specification has been described in terms of some specific embodiments. They are intended for illustration only, and should not be construed as being limiting in any way. Thus, it should be understood that modifications can be made thereto, which are within the scope of the present specification and the appended claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A system for health monitoring of a prime mover coupled to a doubly-fed induction generator (DFIG), wherein the DFIG comprises a generator having a rotor winding and a stator winding, the system comprising:
one or more first sensors coupled to the stator winding of the generator to generate three-phase stator current signals;
one or more second sensors coupled to the rotor winding of the generator to generate three-phase rotor current signals; and
a signal processor operably coupled to the one or more first sensors and the one or more second sensors, the signal processor is configured to:
determine a torque profile of the prime mover based on the three-phase stator current signals and the three-phase rotor current signals; and
detect an anomaly associated with the prime mover if the determined torque profile of the prime mover is abnormal.

2. The system of claim 1, wherein the signal processor is further configured to determine whether the determined torque profile of the prime mover is abnormal by comparing the determined torque profile with a reference torque profile of the prime mover.

3. The system of claim 1, wherein the signal processor is further configured to:
convert the three-phase stator current signals into two-phase stator current signals comprising a d-axis stator current signal and a q-axis stator current signal; and
convert the three-phase rotor current signals into two-phase rotor current signals comprising a d-axis rotor current signal and a q-axis rotor current signal.

4. The system of claim 3, wherein the signal processor is configured to determine the torque profile based on the two-phase stator current signals and the two-phase rotor current signals.

5. The system of claim 3, wherein the signal processor is configured to:
determine an abnormal region in the determined torque profile of the prime mover; and
detect the anomaly associated with the prime mover based on a position of the abnormal region, and the d-axis stator current signal and the d-axis rotor current signal corresponding to the abnormal region.

6. The system of claim 5, wherein the signal processor is further configured to determine a severity of the anomaly associated with the prime mover based on a difference in magnitudes of the d-axis stator current signal and the d-axis rotor current signal, a rate of change of the magnitude of the d-axis rotor current signal, a difference in phase angles of the d-axis stator current signal and the d-axis rotor current signal, a rate of change of the difference in magnitudes of the d-axis stator current signal and the d-axis rotor current signal, a rate of change of the difference in phase angles of the d-axis stator current signal and the d-axis rotor current signal, or combinations thereof.

7. The system of claim 1, wherein the anomaly associated with the prime mover comprises a malfunctioning of one or more cylinders, quality degradation of a lubricant, cylinder knocking, cylinder misfiring, or combinations thereof.

8. The system of claim 1, wherein the one or more first sensors and the one or more second sensors are current sensors.

9. The system of claim 1, wherein the one or more first sensors and the one or more second sensors are voltage sensors.

10. The system of claim 1, wherein the prime mover is an engine disposed on a vehicle.

11. A power generation system, comprising:
an engine operable at variable speeds;
a doubly-fed induction generator (DFIG) mechanically coupled to the engine, wherein the DFIG comprises a generator having a rotor winding and a stator winding;
a system for health monitoring of the engine, wherein the system is operably coupled to the generator of the DFIG and comprising:
one or more first sensors operably coupled to the stator winding of the generator to generate three-phase stator current signals;
one or more second sensors operably coupled to the rotor winding of the generator to generate three-phase rotor current signals; and
a signal processor operably coupled to the one or more first sensors and the one or more second sensors, the signal processor is configured to:
determine a torque profile of the engine based on the three-phase stator current signals and the three-phase rotor current signals;
determine whether the determined torque profile of the engine is abnormal by comparing the determined torque profile with a reference torque profile of the engine; and
detect an anomaly associated with the engine in response to determining that the determined torque profile of the engine is abnormal.

12. The power generation system of claim 11, wherein the generator is configured to:
generate a first electrical power at the stator winding, wherein the first electrical power is at least partially constituted by the three-phase stator current signals; and
generate or absorb a second electrical power at the rotor winding, wherein the second electrical power is at least partially constituted by the three-phase rotor current signals.

13. The power generation system of claim 11, further comprising:
a rotor side converter electrically coupled to the rotor winding; and
a line side converter electrically coupled to the stator winding, wherein the rotor side converter is electrically coupled to the line side converter via a direct-current (DC) link.

14. The power generation system of claim 13, further comprising at least one of:
a renewable energy source electrically coupled to the DC-link and configured to supply a third electrical power to the DC-link; and
an energy storage device electrically coupled to the DC-link and configured to supply a fourth electrical power to the DC-link.

15. The power generation system of claim 14, wherein the renewable energy source comprises a photo-voltaic (PV) power source.

16. The power generation system of claim 15, wherein the signal processor is further configured to:
convert the three-phase stator current signals into two-phase stator current signals comprising a d-axis stator current signal and a q-axis stator current signal; and
convert the three-phase rotor current signals into two-phase rotor current signals comprising a d-axis rotor current signal and a q-axis rotor current signal, wherein the torque profile of the engine is determined based on the two-phase stator current signals and the two-phase rotor current signals.

17. The power generation system of claim 16, wherein the signal processor is configured to:
determine an abnormal region in the determined torque profile of the engine; and
detect the anomaly associated with the engine based on a position of the abnormal region, and the d-axis stator current signal and the d-axis rotor current signal corresponding to the abnormal region.

18. A method for health monitoring of a prime mover coupled to a doubly-fed induction generator (DFIG), wherein the DFIG comprises a generator having a rotor winding and a stator winding, the method comprising:
receiving three-phase stator current signals from one or more first sensors operably coupled to the stator winding;
receiving three-phase rotor current signals from one or more second sensors operably coupled to the rotor winding;
determining a torque profile of the prime mover based on the three-phase stator current signals and the three-phase rotor current signals;
determining whether the determined torque profile of the prime mover is abnormal by comparing the determined torque profile with a reference torque profile of the prime mover; and
detecting an anomaly associated with the prime mover in response to determining that the determined torque profile of the prime mover is abnormal.

19. The method of claim 18, further comprising:
converting the three-phase stator current signals into two-phase stator current signals comprising a d-axis stator current signal and a q-axis stator current signal; and
converting the three-phase rotor current signals into two-phase rotor current signals comprising a d-axis rotor current signal and a q-axis rotor current signal, wherein the torque profile is determined based on the two-phase stator current signals and the two-phase rotor current signals.

20. The method of claim 19, wherein detecting the anomaly associated with the prime mover comprises:
determining an abnormal region in the determined torque profile of the prime mover; and
detecting the anomaly associated with the prime mover based on a position of the abnormal region, and the d-axis stator current signal and the d-axis rotor current signal corresponding to the abnormal region.

21. The method of claim 19, further comprising determining a severity of the anomaly associated with the prime mover based on a difference in magnitudes of the d-axis stator current signal and the d-axis rotor current signal, a difference in phase angles of the d-axis stator current signal and the d-axis rotor current signal, a rate of change of the difference in magnitudes of the d-axis stator current signal and the d-axis rotor current signal, a rate of change of the difference in phase angles of the d-axis stator current signal and the d-axis rotor current signal, or combinations thereof.

22. A method for health monitoring of a prime mover coupled to a doubly-fed induction generator (DFIG), the method comprising:
receiving three-phase rotor current signals from one or more second sensors operably coupled to a rotor winding of the DFIG;
converting the three-phase rotor current signals into two-phase rotor current signals;
extracting rotor current component magnitudes and spatial positions corresponding to the two-phase rotor current signals; and
analyzing the rotor current component magnitudes and the spatial positions corresponding to the two-phase rotor current signals to detect an anomaly associated with the prime mover.
